(19) United States
(12) Patent Application Publication
(10) Pub. No.: US 2025/0163082 A1
(43) Pub. Date: May 22, 2025

(54) TIN PRECURSOR COMPOUNDS AND RELATED COMPOSITIONS AND METHODS

(71) Applicant: ENTEGRIS, INC., Billerica, MA (US)

(72) Inventors: Claudia Fafard, New Milford, CT (US); David M. Ermert, Danbury, CT (US)

(21) Appl. No.: 18/947,539

(22) Filed: Nov. 14, 2024

Related U.S. Application Data
(60) Provisional application No. 63/601,524, filed on Nov. 21, 2023.

(51) Int. Cl. C07F 7/22

(52) U.S. Cl. CPC C07F 7/2284

(57) ABSTRACT

Tin precursor compounds and related compositions and methods are provided. A composition comprises a compound of the formula:

[(R¹)N [symbol] C(R²) [symbol] E]ₐSn(Q)_{b},
where: a+b=2 or 4; R¹ independently comprises at least one of a hydrogen, an alkyl, an alkenyl, an aryl, a silyl, or any combination thereof; R² independently comprises at least one of a hydrogen, an alkyl, an alkenyl, an aryl, a silyl, an amine, an alkoxide, or any combination thereof; E independently comprises N(R³), O, or S, where: R³ independently comprises at least one of a hydrogen, an alkyl, an alkenyl, an aryl, a silyl, or any combination thereof; and Q independently comprises a hydrogen, an alkyl, an alkenyl, an aryl, a silyl, an amine, an alkoxide, a halogen, or any combination thereof. Other precursor compounds, compositions, and methods are provided.

### CROSS-REFERENCE TO RELATED APPLICATIONS

This application claims the benefit under 35 USC 119 of U.S. Provisional Patent Application No. 63/601,524, filed Nov. 21, 2023, the disclosure of which is hereby incorporated herein by reference in its entirety.

### FIELD

The present disclosure relates to tin precursor compounds and related compositions and methods.

### BACKGROUND

Some precursors are useful in the manufacture of microelectronic devices. The manufacture of such devices can involve use of deposition processes to form thin films, as well as extreme ultraviolet (EUV) lithography to form thin films.

### SUMMARY

Some embodiments relate to a composition. In some embodiments, the composition comprises a compound of the formula:

[(R¹)N [symbol] C(R²) [symbol] E]ₐSn(Q)_{b},
where:

$$a + b = 2 or 4 ;$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an alkoxide, or any combination thereof;
E independently comprises N(R³), O, or S, where:
R³ independently comprises at least one of a hydrogen, an alkyl, an alkenyl, an aryl, a silyl, or any combination thereof; and
Q independently comprises a hydrogen, an alkyl, an alkenyl, an aryl, a silyl, an amine, an alkoxide, a halogen, or any combination thereof.

Some embodiments relate to a method. In some embodiments, the method comprises contacting a compound of the formula:

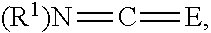

with a compound of the formula:

Sn(R²)ₘ(Q)ₙ,
to form a compound of the formula:

[(R¹)N [symbol] C(R²) [symbol] E]ₐSn(R²)_{b}(Q)_{c},
where:

$$\begin{matrix}m + n = 2 or 4 ; \\ a + b + c = 2 or 4 ;\end{matrix}$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an amide, an alkoxide, or any combination thereof; E independently comprises N(R³), O, or S, where:
R³ independently comprises at least one of a hydrogen, an alkyl, an alkenyl, an aryl, a silyl, or any combination thereof; and
Q independently comprises at least one of a hydrogen, an alkyl, an alkenyl, an aryl, a silyl, an amine, an alkoxide, a halogen, or any combination thereof.

Some embodiments relate to a method. In some embodiments, the method comprises contacting a compound of the formula:

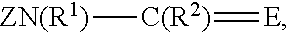

with a compound of the formula:

Sn(Q)ₙ,
to form a compound of the formula:

[(R¹)N [symbol] C(R²) [symbol] E]ₐSn(Q)_{b},
where:
n is 2 or 4;

$$a + b = 2 or 4 ;$$

Z is a hydrogen (H) or a metal (M);
R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, or any combination thereof;
E independently comprises N(R³), O, or S, where:
R³ independently comprises at least one of a hydrogen, an alkyl, an alkenyl, an aryl, a silyl, or any combination thereof; and
Q independently comprises a hydrogen, an alkyl, an alkenyl, an aryl, a silyl, an amine, an alkoxide, a halogen, or any combination thereof.

### DETAILED DESCRIPTION

Among those benefits and improvements that have been disclosed, other objects and advantages of this disclosure will become apparent from the following description taken in conjunction with the accompanying FIGURES. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₈alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₈alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylaminos may include, without limitation, one or more of the following: primary alkylaminos, such as, for example and without limitation, methylamino, ethylamino, n-propylamino, isopropylamino, n-butylamino, sec-butylamino, isobutylamino, t-butylamino, pentylamino, 2-aminopentane, 3-aminopentane, 1-amino-2-methylbutane, 2-amino-2-methylbutane, 3-amino-2-methylbutane, 4-amino-2-methylbutane, hexylamino, 5-amino-2-methylpentane, heptylamino, octylamino, nonylamino, decylamino, undecylamino, dodecylamino, tridecylamino, tetradecylamino, pentadecylamino, hexadecylamino, heptadecylamino, and octadecylamino; and secondary alkylaminos, such as, for example and without limitation, dimethylamino, diethylamino, dipropylamino, diisopropylamino, dibutylamino, diisobutylamino, di-sec-butylamino, di-t-butylamino, dipentylamino, dihexylamino, diheptylamino, dioctylamino, dinonylamino, didecylamino, methylethylamino, methylpropylamino, methylisopropylamino, methylbutylamino, methylisobutylamino, methyl-sec-butylamino, methyl-t-butylamino, methylamylamino, methylisoamylamino, ethylpropylamino, ethylisopropylamino, ethylbutylamino, ethylisobutylamino, ethyl-sec-butylamino, ethylamino, ethylisoamylamino, propylbutylamino, and propylisobutylamino. Unless otherwise provided herein, the terms “amine” and “amino” may be used interchangeably throughout this disclosure.

As used herein, the term “alkoxy” or “alkoxide” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “silyl” refers to a functional group of formula —Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}R^{c}R^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “haloalkyl” refers to an alkyl as defined here, wherein at least one of the hydrogen atoms of the alkyl is replaced with a halide as defined herein. In some embodiments, the haloalkyl comprises a fluoroalkyl. In some embodiments, the fluoroalkyl comprises at least one of —CH₂CF₃, —CH(CF₃)₂, —CH₂F, —CH₂CH₂F, —CF₃, —CF₂CF₃, or any combination thereof.

As used herein, the term “halogen” refers to a —Cl, —Br, —I, or —F.

As used herein, the term “metal” refers to at least one of an alkali metal, an alkaline earth metal, a transition metal, a post-transition metal, or any combination thereof. In some embodiments, the metal comprises a metal cation. In some embodiments, the metal cation comprises at least one of a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallum cation, a lead cation, a bismuth cation, a polonium cation, or any combination thereof. The charge(s) of the metal cations are known and, for simplicity, thus are not repeated here; however, it will be appreciated that the metal cations can have any known charge.

Some embodiments relate to compositions useful in extreme-ultraviolet (EUV) lithography, among other applications, and related methods. The compositions disclosed herein comprise tin precursor compounds. The tin precursor compounds may be used to form tin-containing films useful in the fabrication of microelectronic devices, including semiconductor devices. In some embodiments, for example, the tin precursor compounds comprise tin (IV) monoalkyl species with at least one mono-ionic bidentate ligand. The precursor compositions may be used as deposition precursors for generating tin-containing films. The tin-containing films may be used in dry resist applications or as reflective coatings for extreme-ultraviolet (EUV) lithography, among others. The precursor compositions may be formed according to the methods disclosed herein in high yield and high purity, while also minimizing the number of steps required to produce the precursor compositions.

The tin-containing films may also be formed according to the methods disclosed herein. That is, the tin-containing films disclosed herein may be formed by one or more deposition processes that utilize the precursor compositions. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

Some embodiments relate to a composition. In some embodiments, the composition comprises a precursor compound. For example, in some embodiments, the composition comprises a compound of the formula:

[(R¹)N [symbol] C(R²) [symbol] E]ₐSn(Q)_{b},
where:

$$a + b = 2 or 4 ;$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an alkoxide, or any combination thereof;
E independently comprises N(R³), O, or S, where:
R³ independently comprises at least one of a hydrogen, an alkyl, an alkenyl, an aryl, a silyl, or any combination thereof;
Q independently comprises a hydrogen, an alkyl, an alkenyl, an aryl, a silyl, an amine, an alkoxide, a halogen, or any combination thereof.

In some embodiments, E is N(R³); Q is independently a halogen; a is 1; and b is 3.

In some embodiments, E is N(R³); Q independently comprises at least one of a halogen, an amine, or any combination thereof; a is 2; and b is 2.

In some embodiments, E is O or S; Q is independently a halogen; a is 1; and b is 3.

In some embodiments, E is O or S; Q independently comprises at least one of a halogen, an amine, or any combination thereof; a is 2; and b is 2.

In some embodiments, E is N(R³); Q is a halogen; a is 1; and b is 1.

In some embodiments, E is N(R³); a is 2; and b is 0.

In some embodiments, E is O or S; Q is a halogen; a is 1; and b is 1.

In some embodiments, E is O or S; a is 2; and b is 0.

In some embodiments, the compound comprises at least one of the following:

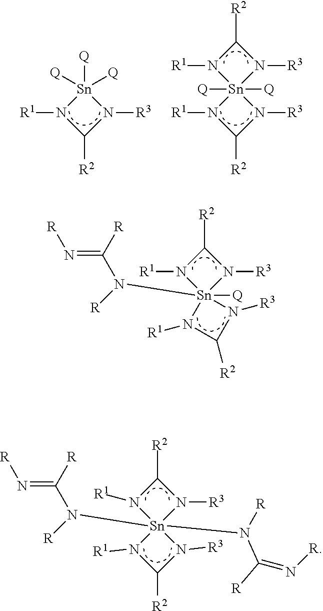

In some embodiments, the compound comprises at least one of the following:

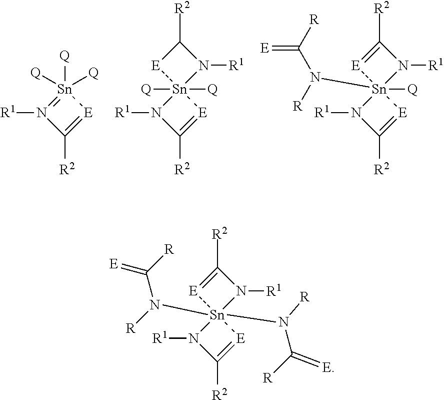

In some embodiments, the compound comprises at least one of the following:

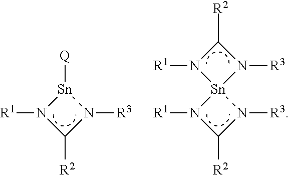

In some embodiments, the compound comprises at least one of the following:

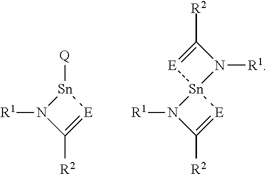

In some embodiments, the compound is present in the composition at a purity of 95% to 99.9999%, or any range or subrange between 95% and 99.9999%. In some embodiments, the compound is present in the composition at a purity of 96% to 99.9999%, 97% to 99.9999%, 98% to 99.9999%, 99% to 99.9999%, 99.9% to 99.9999%, 99.99% to 99.9999%, 99.999% to 99.9999%, 95% to 99.999%, 95% to 99.99%, 95% to 99.9%, 95% to 99%, 95% to 98%, 95% to 97%, or 95% to 96%.

Some embodiments relate to a method of forming a precursor compound. In some embodiments, the method of forming a precursor compound comprises contacting a compound of the formula:

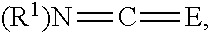

with a compound of the formula:

Sn(R²)ₘ(Q)ₙ,
to form a compound of the formula:

[(R¹)N [symbol] C(R²) [symbol] E]ₐSn(R²)_{b}(Q)_{c},
where:

$$\begin{matrix}m + n = 2 or 4 ; \\ a + b + c = 2 or 4 ;\end{matrix}$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an amide, an alkoxide, or any combination thereof;
E independently comprises N(R³), O, or S, where:
R³ independently comprises at least one of a hydrogen, an alkyl, an alkenyl, an aryl, a silyl, or any combination thereof;
Q independently comprises at least one of a hydrogen, an alkyl, an alkenyl, an aryl, a silyl, an amine, an alkoxide, a halogen, or any combination thereof.

In some embodiments, E is N(R³); Q is independently a halogen; m is 1; n is 3; a is 1; b is 1; and c is 3.

In some embodiments, E is O or S; Q is independently a halogen; m is 1; n is 3; a is 1; b is 1; and c is 3.

In some embodiments, E is N(R³); Q is a halogen; m is 1; n is 1; a is 1; b is 1; and c is 1.

In some embodiments, E is O or S; Q is a halogen; m is 1; n is 1; a is 1; b is 1; and c is 1.

In some embodiments, the method comprises:

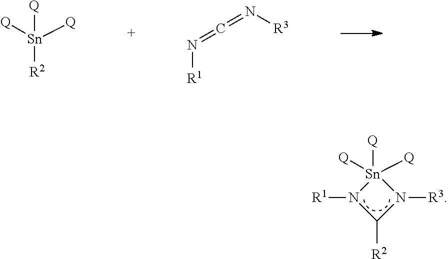

In some embodiments, the method comprises:

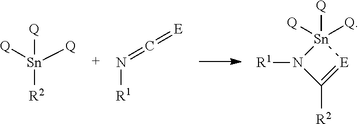

In some embodiments, the method comprises:

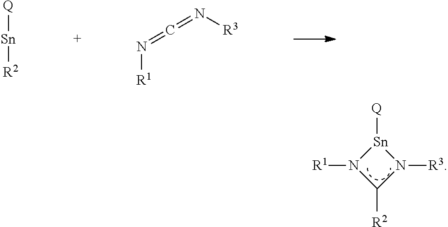

In some embodiments, the method comprises:

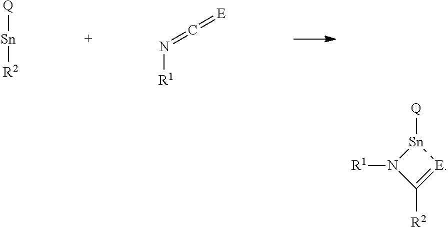

In some embodiments, the compound is produced at a purity of 95% to 99.9999%, or any range or subrange between 95% and 99.9999%. In some embodiments, the compound is present in the composition at a purity of 96% to 99.9999%, 97% to 99.9999%, 98% to 99.9999%, 99% to 99.9999%, 99.9% to 99.9999%, 99.99% to 99.9999%, 99.999% to 99.9999%, 95% to 99.999%, 95% to 99.99%, 95% to 99.9%, 95% to 99%, 95% to 98%, 95% to 97%, or 95% to 96%.

Some embodiments relate to a method of forming a precursor compound. In some embodiments, the method of forming a precursor compound comprises contacting a compound of the formula:

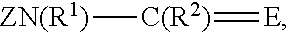

with a compound of the formula:

Sn(Q)ₙ,
to form a compound of the formula:

[(R¹)N [symbol] C(R²) [symbol] E]ₐSn(Q)_{b},
where:
n is 2 or 4;

$$a + b = 2 or 4 ;$$

Z is a hydrogen (H) or a metal (M);
R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, or any combination thereof;
E independently comprises N(R³), O, or S, where:
R³ independently comprises at least one of a hydrogen, an alkyl, an alkenyl, an aryl, a silyl, or any combination thereof;
Q independently comprises a hydrogen, an alkyl, an alkenyl, an aryl, a silyl, an amine, an alkoxide, a halogen, or any combination thereof.

In some embodiments, the contacting further forms a compound of the formula MQ.

In some embodiments, Z is a metal; E is N(R³); n is 4; a is 1; and b is 3.

In some embodiments, Z is a metal; E is O or S; n is 4; a is 1; and b is 3.

In some embodiments, Z is a metal; E is N(R³); n is 2; a is 1; and b is 1.

In some embodiments, Z is a metal; E is O or S; n is 2; a is 1; and b is 1.

In some embodiments, the method comprises:

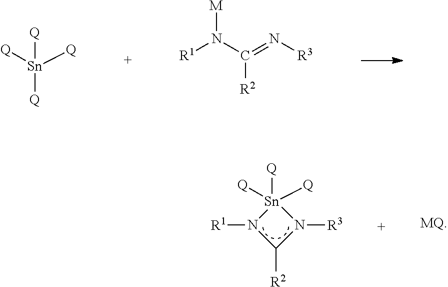

In some embodiments, the method comprises:

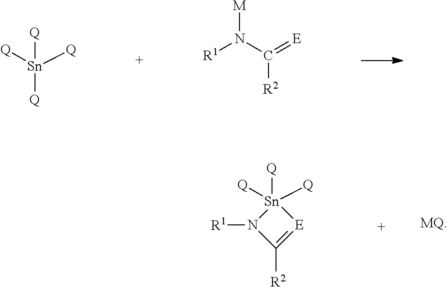

In some embodiments, the method comprises:

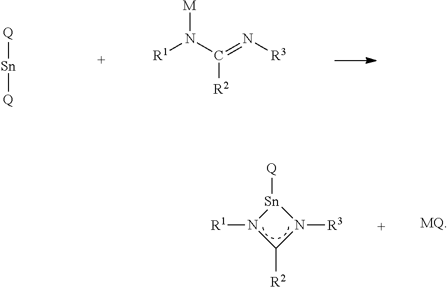

In some embodiments, the method comprises:

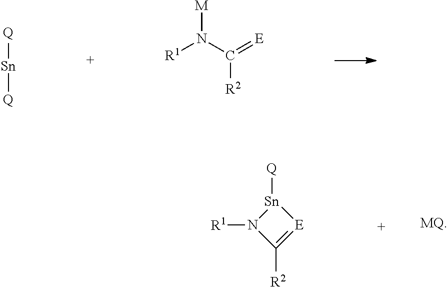

In some embodiments, the method comprises: the contacting further forms a compound of the formula HZ.

In some embodiments, Z is a metal; E is N(R³); n is 4; a is 1; and b is 3.

In some embodiments, Z is a metal; E is O or S; n is 4; a is 1; and b is 3.

In some embodiments, Z is a metal; E is N(R³); n is 2; a is 1; and b is 1.

In some embodiments, Z is a metal; E is O or S; n is 2; a is 1; and b is 1.

In some embodiments, the method comprises:

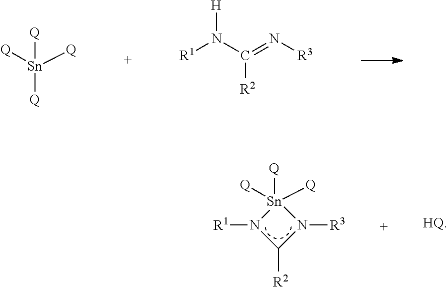

In some embodiments, the method comprises:

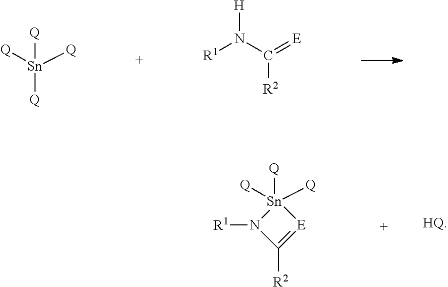

In some embodiments, the method comprises:

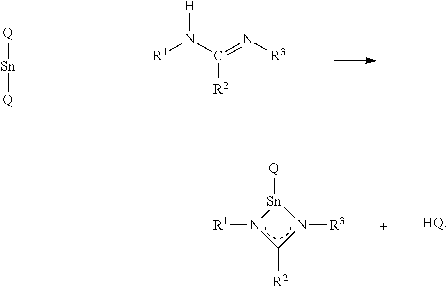

In some embodiments, the method comprises:

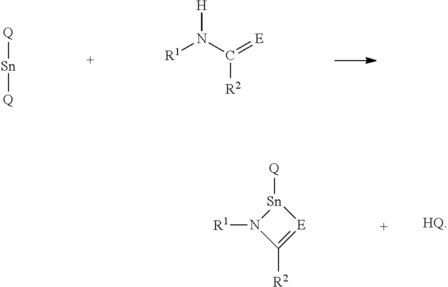

In some embodiments, the compound is present in the composition at a purity of 95% to 99.9999%, or any range or subrange between 95% and 99.9999%. In some embodiments, the compound is present in the composition at a purity of 96% to 99.9999%, 97% to 99.9999%, 98% to 99.9999%, 99% to 99.9999%, 99.9% to 99.9999%, 99.99% to 99.9999%, 99.999% to 99.9999%, 95% to 99.999%, 95% to 99.99%, 95% to 99.9%, 95% to 99%, 95% to 98%, 95% to 97%, or 95% to 96%.

### Example 1

### Synthesis of iPrSn(NMe₂)₂[(iPr)NC(NMe₂)N(iPr)]

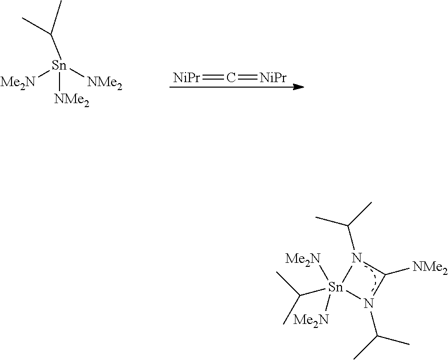

A tin (IV) compound of the formula Sn(N(CH₃)₂)₃(iPr) (5 g, 17.0 mmol) was diluted in 10 mL of anhydrous hexanes and cooled to −10 C. To this solution a carbodiimide of the formula N(iPr)=C═N(iPr) (2.14 g, 17.0 mmol) was added slowly dropwise. The solvent then was removed under vacuum and yielded a clear viscous liquid: mass 7.3 g, yield: 100%. Purity: 97.1% by ¹¹⁹Sn-NMR. ¹¹⁹Sn{¹H}-NMR (149 MHZ, C₆D₆, 298K): −199.9 ppm; ¹H {¹³C}-NMR (400 MHZ, C₆D₆, 298K): 1.06 (12H), 1.41 (6H), 1.75 (1H), 2.52 (6H), 2.75 (12H), 3.46 (2H); ¹³C {¹H}-NMR (100 MHZ, C₆D₆, 298K): 21.04, 24.58, 26.45, 40.36, 43.81, 46.62, 164.79.

### Example 2

### Synthesis of iPrSn(NMe₂)[(iPr)NC(NMe₂)N(iPr)]₂

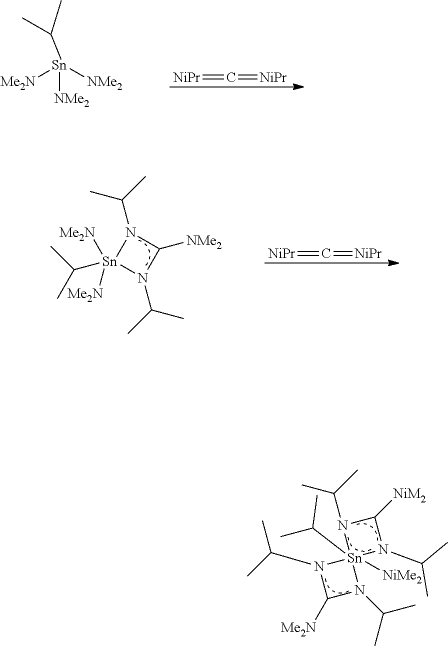

A tin (IV) compound of the formula Sn(N(CH₃)₂)₃(iPr) (1 g, 3.40 mmol) was diluted in 1 mL of anhydrous C₆D₆. To this solution a carbodiimide of the formula N(iPr)=C═N(iPr) (1.28 g, 10.2 mmol) was added slowly dropwise. ¹¹⁹Sn{¹H}-NMR (149 MHZ, C₆D₆, 298K): −406.2 ppm.

### Example 3

### Synthesis of Sn(NMe₂)₂[(iPr)NC(NMe₂)N(iPr)]₂

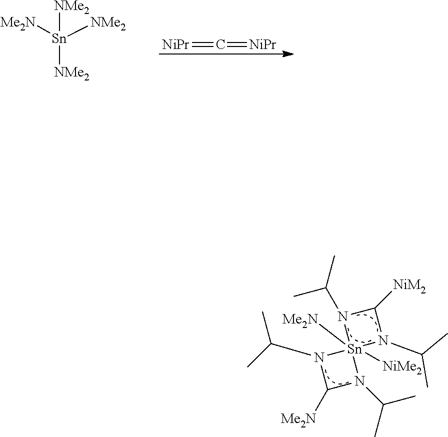

A tin (IV) compound of the formula Sn(N(CH₃)₂)₄ (5 g, 16.9 mmol) was diluted in 50 mL of anhydrous hexanes. To this solution a carbodiimide of the formula N(iPr)=C═N(iPr) (2.14 g, 17.0 mmol) was added slowly dropwise; an exotherm was observed. The rate of addition was such to maintain a solution temperature below 30 C. The reaction solution was stirred overnight and the following day the solvent was removed under vacuum. A sticky solid was obtained. The material was dissolved in ˜7 mL of hexanes and cooled to −35 C. A crystalline white solid was collected: mass 7.7 g, yield: 83%. Melting Point: 61.1° C. (by DSC) Purity: 100% by ¹¹⁹Sn-NMR. ¹¹⁹Sn{¹H}-NMR (149 MHZ, NEAT, 298K): −478.4 ppm; ¹H {¹³C}-NMR (400 MHZ, C₆D₆, 298K): 1.18-1.38 (multiple d, 24H), 2.52 (s, 12H), 2.99 (s, 12H), 3.55-3.72 (m, 4H); ¹³C{¹H}-NMR (100 MHZ, C₆D₆, 298K): 23.20, 24.28, 24.54, 25.51, 40.34, 44.29, 46.85, 165.74.

### ASPECTS

Various Aspects are described below. It is to be understood that any one or more of the features recited in the following Aspect(s) can be combined with any one or more other Aspect(s).
Aspect 1. A composition comprising:
   a compound of the formula:

[(R¹)N [symbol] C(R²) [symbol] E]ₐSn(Q)_{b},
where:

$$a + b = 2 or 4 ;$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an alkoxide, or any combination thereof;
E independently comprises N(R³), O, or S, where:
R³ independently comprises at least one of a hydrogen, an alkyl, an alkenyl, an aryl, a silyl, or any combination thereof;
Q independently comprises a hydrogen, an alkyl, an alkenyl, an aryl, a silyl, an amine, an alkoxide, a halogen, or any combination thereof.
Aspect 2. The composition according to Aspect 1,
   wherein:
      E is N(R³);
      Q is independently a halogen;
      a is 1;
      b is 3.
Aspect 3. The composition according to Aspect 1,
   wherein:
      E is N(R³);
      Q independently comprises at least one of a halogen, an amine, or any combination thereof;
      a is 2; and
      b is 2.
Aspect 4. The composition according to Aspect 1,
   wherein:
      E is O or S;
      Q is independently a halogen;
      a is 1; and
      b is 3.
Aspect 5. The composition according to Aspect 1,
   wherein:
      E is O or S;
      Q independently comprises at least one of a halogen, an amine, or any combination thereof;
      a is 2; and
      b is 2.
Aspect 6. The composition according to Aspect 1,
   wherein:
      E is N(R³);
      Q is a halogen;
      a is 1; and
      b is 1.
Aspect 7. The composition according to Aspect 1,
   wherein:
      E is N(R³);
      a is 2; and
      b is 0.
Aspect 8. The composition according to Aspect 1,
   wherein:
      E is O or S;
      Q is a halogen;
      a is 1; and
      b is 1.
Aspect 9. The composition according to Aspect 1,
   wherein:
      E is O or S;
      a is 2; and
      b is 0.
Aspect 10. The composition according to Aspect 1, wherein the compound comprises at least one of the following:

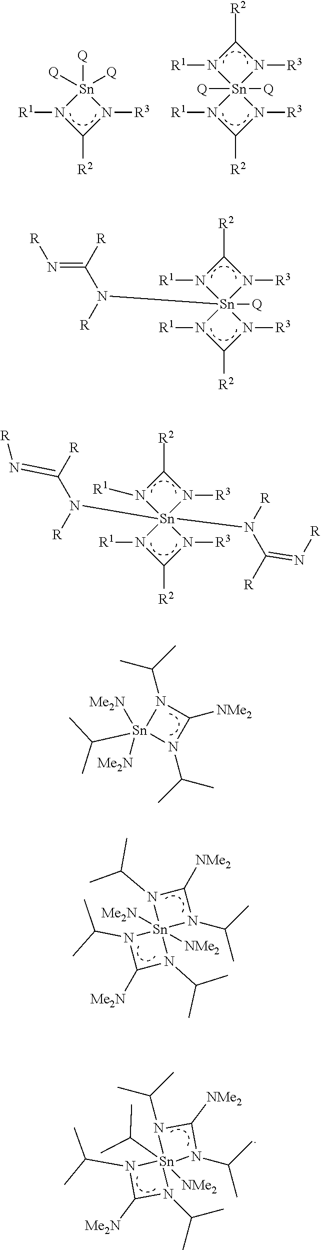

Aspect 11. The composition according to Aspect 1, wherein the compound comprises at least one of the following:

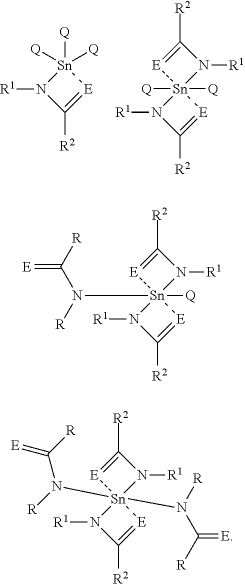

Aspect 12. The composition according to Aspect 1, wherein the compound comprises at least one of the following:

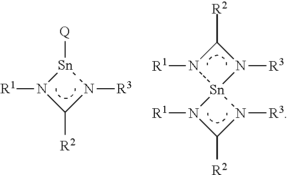

Aspect 13. The composition according to Aspect 1, wherein the compound comprises at least one of the following:

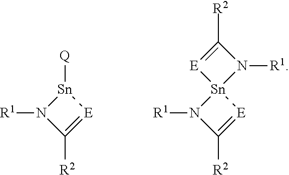

Aspect 14. A method comprising:
   contacting a compound of the formula:

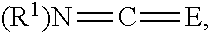

with a compound of the formula:

Sn(R²)ₘ(Q)ₙ,
to form a compound of the formula:

[(R¹)N [symbol] C(R²) [symbol] E]ₐSn(R²)_{b}(Q)_{c},
where:

$$\begin{matrix}m + n = 2 or 4 ; \\ a + b + c = 2 or 4 ;\end{matrix}$$

R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an amide, an alkoxide, or any combination thereof;
E independently comprises N(R³), O, or S, where:
   R³ independently comprises at least one of a hydrogen, an alkyl, an alkenyl, an aryl, a silyl, or any combination thereof;
Q independently comprises at least one of a hydrogen, an alkyl, an alkenyl, an aryl, a silyl, an amine, an alkoxide, a halogen, or any combination thereof.
Aspect 15. The method according to Aspect 14,
   wherein:
      E is N(R³);
      Q is independently a halogen;
      m is 1;
      n is 3;
      a is 1;
      b is 1; and
      c is 3.
Aspect 16. The method according to Aspect 14,
   wherein:
      E is O or S;
      Q is independently a halogen;
      m is 1;
      n is 3;
      a is 1;
      b is 1; and
      c is 3.
Aspect 17. The method according to Aspect 14,
   wherein:
      E is N(R³);
      Q is a halogen;
      m is 1;
      n is 1;
      a is 1;
      b is 1; and
      c is 1.
Aspect 18. The method according to Aspect 14,
   wherein:
      E is O or S;
      Q is a halogen;
      m is 1;
      n is 1;
      a is 1;
      b is 1; and
      c is 1.
Aspect 19. The method according to Aspect 14, wherein the method comprises:

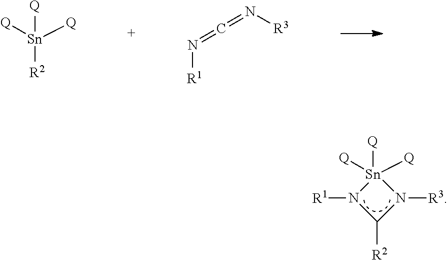

Aspect 20. The method according to Aspect 14, wherein the method comprises:

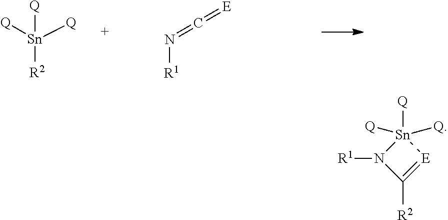

Aspect 21. The method according to Aspect 14, wherein the method comprises:

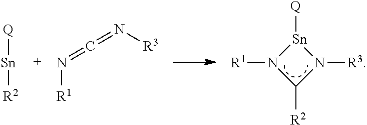

Aspect 22. The method according to Aspect 14, wherein the method comprises:

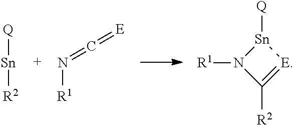

Aspect 23. A method comprising:
   contacting a compound of the formula:

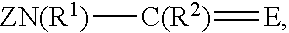

with a compound of the formula:

Sn(Q)ₙ,
to form a compound of the formula:

[(R¹)N [symbol] C(R²) [symbol] E]ₐSn(Q)_{b},
where:
   n is 2 or 4;

$$a + b = 2 or 4 ;$$

Z is a hydrogen (H) or a metal (M);
R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, or any combination thereof;
E independently comprises N(R³), O, or S, where:
R³ independently comprises at least one of a hydrogen, an alkyl, an alkenyl, an aryl, a silyl, or any combination thereof;
Q independently comprises a hydrogen, an alkyl, an alkenyl, an aryl, a silyl, an amine, an alkoxide, a halogen, or any combination thereof.
Aspect 24. The method according to Aspect 23, wherein the contacting further forms a compound of the formula MQ.
Aspect 25. The method according to Aspect 24,
   wherein:
      Z is a metal;
      E is N(R³);
      n is 4;
      a is 1; and
      b is 3.
Aspect 26. The method according to Aspect 24,
   wherein:
      Z is a metal;
      E is O or S;
      n is 4;
      a is 1; and
      b is 3.
Aspect 27. The method according to Aspect 24,
   wherein:
      Z is a metal;
      E is N(R³);
      n is 2;
      a is 1; and
      b is 1.
Aspect 28. The method according to Aspect 24,
   wherein:
      Z is a metal;
      E is O or S;
      n is 2;
      a is 1; and
      b is 1.
Aspect 29. The method according to Aspect 24, wherein the method comprises:

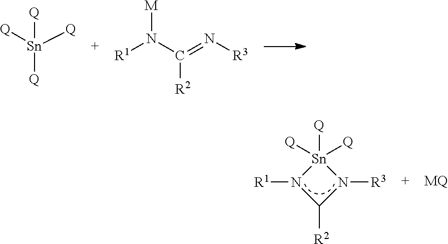

Aspect 30. The method according to Aspect 24, wherein the method comprises:

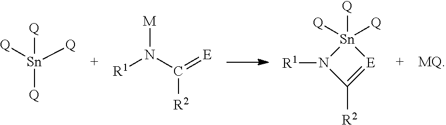

Aspect 31. The method according to Aspect 24, wherein the method comprises:

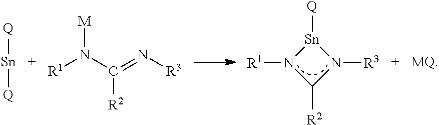

Aspect 32. The method according to Aspect 24, wherein the method comprises:

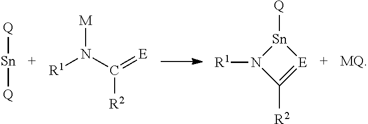

Aspect 33. The method according to Aspect 23, wherein the contacting further forms a compound of the formula HZ.
Aspect 34. The method according to Aspect 33,
   wherein:
      Z is a metal;
      E is N(R³);
      n is 4;
      a is 1; and
      b is 3.
Aspect 35. The method according to Aspect 33,
   wherein:
      Z is a metal;
      E is O or S;
      n is 4;
      a is 1; and
      b is 3.
Aspect 36. The method according to Aspect 33,
   wherein:
      Z is a metal;
      E is N(R³);
      n is 2;
      a is 1; and
      b is 1.
Aspect 37. The method according to Aspect 33,
   wherein:
      Z is a metal;
      E is O or S;
      n is 2;
      a is 1; and
      b is 1.
Aspect 34. The method according to Aspect 33, wherein the method comprises:

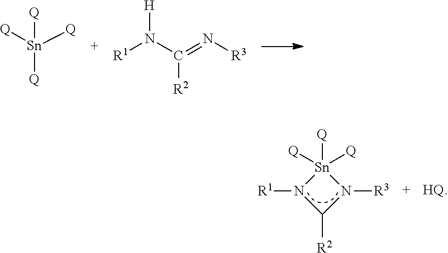

Aspect 35. The method according to Aspect 33, wherein the method comprises:

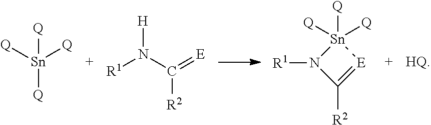

Aspect 36. The method according to Aspect 33, wherein the method comprises:

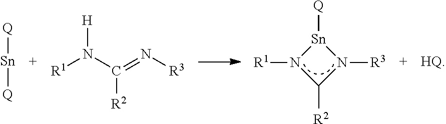

Aspect 37. The method according to Aspect 33, wherein the method comprises:

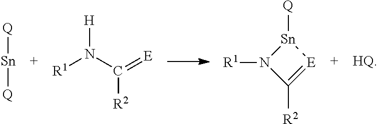

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A composition comprising:
a compound of the formula:
[(R¹)N [symbol] C(R²) [symbol] E]ₐSn(Q)_{b},
where:
$$a + b = 2 or 4 ;$$
R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an alkoxide, or any combination thereof;
E independently comprises N(R³), O, or S, where:
R³ independently comprises at least one of a hydrogen, an alkyl, an alkenyl, an aryl, a silyl, or any combination thereof; and
Q independently comprises a hydrogen, an alkyl, an alkenyl, an aryl, a silyl, an amine, an alkoxide, a halogen, or any combination thereof.

2. The composition of claim 1,
wherein:
E is N(R³);
Q is independently a halogen;
a is 1; and
b is 3.

3. The composition of claim 1,
wherein:
E is N(R³);
Q independently comprises at least one of a halogen, an amine, or any combination thereof;
a is 2; and
b is 2.

4. The composition of claim 1,
wherein:
E is O or S;
Q is independently a halogen;
a is 1; and
b is 3.

5. The composition of claim 1,
wherein:
E is O or S;
Q independently comprises at least one of a halogen, an amine, or any combination thereof;
a is 2; and
b is 2.

6. The composition of claim 1,
wherein:
E is N(R³);
Q is a halogen;
a is 1; and
b is 1.

7. The composition of claim 1,
wherein:
E is N(R³);
a is 2; and
b is 0.

8. The composition of claim 1,
wherein:
E is O or S;
Q is a halogen;
a is 1; and
b is 1.

9. The composition of claim 1,
wherein:
E is O or S;
a is 2; and
b is 0.

10. The composition of claim 1, wherein the compound comprises at least one of the following:

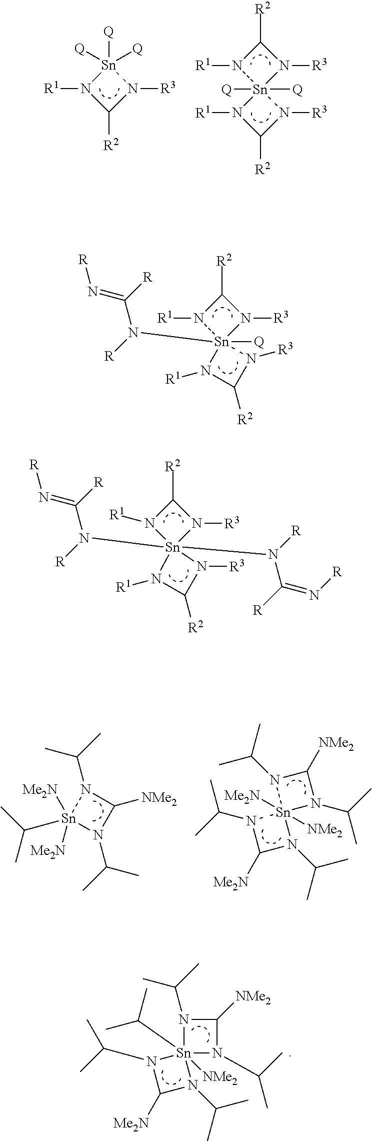

11. The composition of claim 1, wherein the compound comprises at least one of the following:

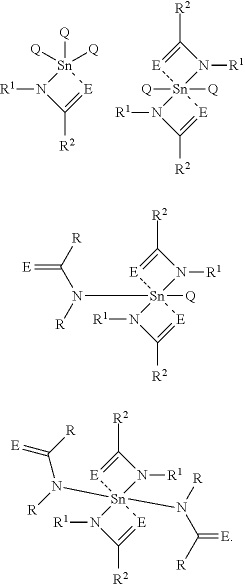

12. The composition of claim 1, wherein the compound comprises at least one of the following:

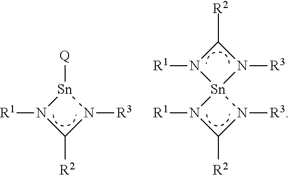

13. The composition of claim 1, wherein the compound comprises at least one of the following:

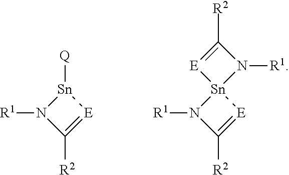

14. A method comprising:
contacting a compound of the formula: 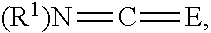
with a compound of the formula:
Sn(R²)ₘ(Q)ₙ,
to form a compound of the formula:
[(R¹)N [symbol] C(R²) [symbol] E]ₐSn(R²)_{b}(Q)_{c},
where:
$$\begin{matrix}m + n = 2 or 4 ; \\ a + b + c = 2 or 4 ;\end{matrix}$$
R¹ independently comprises at least one of a hydrogen, an alkyl, an alkenyl, an aryl, a silyl, or any combination thereof;
R² independently comprises at least one of a hydrogen, an alkyl, an alkenyl, an aryl, a silyl, an amine, an amide, an alkoxide, or any combination thereof;
E independently comprises N(R³), O, or S, where:
R³ independently comprises at least one of a hydrogen, an alkyl, an alkenyl, an aryl, a silyl, or any combination thereof; and
Q independently comprises at least one of a hydrogen, an alkyl, an alkenyl, an aryl, a silyl, an amine, an alkoxide, a halogen, or any combination thereof.

15. The method of claim 14,
wherein:
E is N(R³);
Q is independently a halogen;
m is 1;
n is 3;
a is 1;
b is 1; and
c is 3.

16. The method of claim 14,
wherein:
E is O or S;
Q is independently a halogen;
m is 1;
n is 3;
a is 1;
b is 1; and
c is 3.

17. The method of claim 14,
wherein:
E is N(R³);
Q is a halogen;
m is 1;
n is 1;
a is 1;
b is 1; and
c is 1.

18. The method of claim 14,
wherein:
E is O or S;
Q is a halogen;
m is 1;
n is 1;
a is 1;
b is 1; and
c is 1.

19. The method of claim 14, wherein the method comprises:

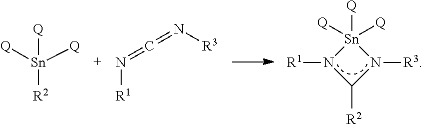

20. The method of claim 14, wherein the method comprises:

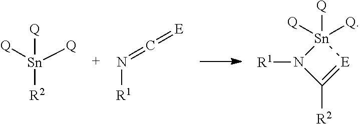

21. The method of claim 14, wherein the method comprises:

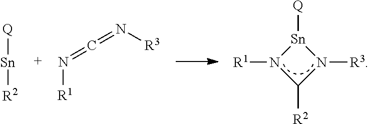

22. The method of claim 14, wherein the method comprises: [chemical structure]
